(19) United States
(12) Patent Application Publication
(10) Pub. No.: US 2002/0040385 A1
(43) Pub. Date: Apr. 4, 2002

(54) Method and device for data communication, and a computer product

(75) Inventors: Yoshiaki Segawa, Kawasaki (JP); Masakazu Watanabe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/804,907

(22) Filed: Mar. 13, 2001

(30) Foreign Application Priority Data
Oct. 4, 2000 (JP) 2000-305303

(51) Int. Cl. G06F 15/173; G06F 15/16

(52) U.S. Cl. 709/203; 709/224

(57) ABSTRACT

The data communication device is provided with an ORB for transmitting reply information corresponding to requests to a plurality of clients, respectively if the requests are issued from those clients, and storing the reply information in a memory and then monitoring connection with these clients. Furthermore, a transaction guarantee section is provided for transmitting the reply information corresponding to the connection to the clients and stored in the memory if connection is abnormally cut off based on a connection monitoring result.

### FIELD OF THE INVENTION

The present invention relates to a technology for reducing communication load when abnormality occurs during communication.

### BACKGROUND OF THE INVENTION

Use of data communication devices consisting of clients and a server are becoming a main stream in recent data communication. In a data communication device of this type, if the number of clients increases, communication load increases accordingly. Means and methods of minimizing communication load as much as possible are, therefore, strongly demanded.

FIG. 9 is a block diagram showing the constitution of a conventional CORBA (Common Object Request Broker Architecture) communication system. CORBA is a standardization specification for connection among different types of devices set by the standardization group or OMG (Object Management Group) and is to specify various API (Application Program Interfaces) for establishing linkage protocols and distributed applications among different types of devices.

Briefly, the CORBA is a standard technique for providing a mechanism for a client to access an object (e.g., an application program) in a server in a distributed system environment. Here, an object in the CORBA means an identifiably capsulate entity providing one or a plurality of services which can be requested from clients.

FIG. 9 shows a CORBA communication system consisting of n clients 10₁ to 10ₙ and a server 20 connected to the clients 10₁ to 10ₙ through a network (not shown). Each of the clients 10₁ to 10ₙ communicates with the server 20 in accordance with a predetermined protocol. In this protocol, processings including request, reply, commitment and rollback are generated.

In a request processing, each of the clients 10₁ to 10ₙ requests a transaction processing of the server 20 and the update of a database 25 in which the transaction is generated. A reply processing is a reply to the request and notified from the server 20 to each of the clients 10₁ to 10ₙ. A commitment processing is to reflect the processing result of each of the clients 10₁ to 10ₙ on the database 25. A rollback processing is to return the state of the database 25 to a state before the transaction is executed and to maintain consistency if the connection between one of the clients 10₁ to 10ₙ and the server 20 is abnormally cut off.

In the client 10₁ , an ORB (Object Request Broker: communication mechanism among distributed objects) 11₁ is a software bus mediating between the client 10₁ and the server 20. The ORB 11₁ has an initial object reference including an IP address and a PORT number of the client 10₁ itself.

Now, a naming service in the CORBA will be described. According to the naming service in the CORBA, if a client accesses an object, the client can do so not by the position of the object but by the name of the object. Due to this, it is not necessary for the client to recognize the physical position of the object.

To be specific, if an object is accessed by a client, an object reference is generated in the server 20 and returned to the client, thereby providing a naming service to the client. This object reference is information for uniquely identifying an objects by its name.

A request transmission section 12₁ has a function of transmitting the above-stated request to the server 20. A reply reception section 13₁ has a function of receiving a reply from the server 20. The reply is a reply to the above-stated request. A commitment/rollback transmission section 14₁ has a function of transmitting the above-stated commitment or rollback to the server 20.

In the client 10₂, an ORB 11₂ is a software bus mediating between the client 10₂ and the server 20 as in the case of the ORB 11₁. This ORB 11₂ has an initial object reference including an IP address and a PORT number of the client 10₂ itself.

A request transmission section 12₂ has a function of transmitting the above-stated request to the server 20. A reply reception section 13₂ has a function of receiving a reply from the server 20. The reply is a reply to the above-stated request. A commitment/rollback transmission section 14₂ has a function of transmitting the above-stated commitment or rollback to the server 20.

In the client 10ₙ, an ORB 11ₙ is a software bus mediating between the client 10ₙ and the server 20 as in the case of the ORB 11₁. This ORB 11ₙ has an initial object reference including an IP address and a PORT number of the client 10ₙ itself.

A request transmission section 12ₙ has a function of transmitting the above-stated request to the server 20. A reply reception section 13ₙ has a function of receiving a reply from the server 20. The reply is a reply to the above-stated request. A commitment/rollback transmission section 14ₙ has a function of transmitting the above-stated commitment or rollback to the server 20.

A server 20 has a function of receiving requests from the clients 10₁ to 10ₙ, a function of transmitting replies to the corresponding requests to the clients 10₁ to 10ₙ, a function of receiving commitments from the clients 10₁ to 10ₙ, a function of updating the database 25 based on the commitments, a function of receiving rollbacks from the clients 10₁ to 10ₙ and a function of returning the state of the database 25 to a state before a transaction is executed based on the rollbacks.

To be specific, the server 20 consists of an ORB 21, a request reception section 22, a reply transmission section 23, a commitment/rollback reception section 24 and a database 25. The ORB 21 is a software bus mediating between the server 20 and the clients 10₁ to 10ₙ. The request reception section 22 has a function of receiving requests from the clients 10₁ to 10ₙ.

The reply transmission section 23 has a function of transmitting replies to the requests to the clients 10₁ to 10ₙ, respectively. The commitment/rollback reception section 24 has a function of receiving commitments from the clients 10₁ to 10ₙ, a function of updating the database 25 based on the commitments, a function of receiving rollbacks from the clients 10₁ to 10ₙ, and a function of returning the state of the database 25 to a state before a transaction is executed based on the rollbacks.

How the conventional CORBA communication system works will be described with reference to FIG. 10. FIG. 10 is a sequence view for describing the operation of the conventional CORBA communication system. First, operation in a normal state between the client 10ₙ and the server 20 will be explained. It is noted that the operation between each of the clients 10₁ to 10ₙ₋₁ (not shown) and the server 20 is the same as that between the client 10ₙ and the server 20 to be described hereinafter.

In a step SA1 shown in FIG. 10, when the request transmission section 12ₙ of the client 10ₙ transmits a request, the request reception section 22 of the server 20 receives the request.

Following this, in a step SA2, when the reply transmission section 23 of the server 20 transmits a reply, the reply reception section 13ₙ receives the reply. In a step SA3, when the commitment/rollback transmission section 14ₙ transmits a commitment, the commitment/rollback reception section 24 receives the commitment. By doing so, the database 25 in the server 20 is updated.

Next, operation when the connection set between the client 10ₙ and the server 20 shown in FIG. 9 is abnormally cut off will be explained. In a step SB1 shown in FIG. 10, when the request transmission section 12ₙ of the client 10ₙ transmits a request, the request reception section 22ₙ of the server 20 receives the request. Following this, in a step SB2, the reply transmission section 23 of the server 20 transmits a reply.

Here, if the connection is abnormally cut off, transaction mismatching occurs and the reply stated above is not received by the reply reception section 13ₙ. In this case, in a step SB3, when the commitment/rollback transmission section 14ₙ transmits a rollback, the commitment/rollback reception section 24 receives the rollback. As a result, the state of the server 20 is returned to a state before the transaction is executed. Namely, in the abnormal state, the database 25 is not updated.

Meanwhile, as already explained above, the conventional CORBA communication system requires communication for commitment/rollback between the clients 10₁ to 10ₙ and the server 20 when abnormality occurs to the communication. Thus, the conventional CORBA communication system has a disadvantage of increasing communication load (transactions) if the number of clients increases. This disadvantage becomes a bottleneck particularly when a network has a low line capacity.

### SUMMARY OF THE INVENTION

It is an object of the present invention to provide a method and device for data communication in which it is possible to reduce communication load at a time when abnormality occurs to communication. It is another object of this invention to provide a computer readable recording medium that stores a computer program which when executed realizes the method according to the present invention.

The data communication device according to one aspect of the present invention comprises a reply unit which, if a request is issued from the external device, transmits reply information corresponding to the request, and stores the reply information in a memory; a connection monitoring unit which monitors connection with the external device; and a transmission unit which transmits the reply information corresponding to the connection and stored in the memory, to the external communication device if the connection is abnormally cut off based on a monitoring result of the connection monitoring unit.

The data communication method according to another aspect of the present invention comprises a reply step of, if a request is issued from the external device, transmitting reply information corresponding to the request, and of storing the reply information in a memory; a connection monitoring step of monitoring connection with the external device; and a transmission step of transmitting the reply information corresponding to the connection and stored in the memory, to the external communication device if the connection is abnormally cut off based on a monitoring result of the connection monitoring step.

The computer readable recording medium according to another aspect of the present invention stores a computer program which when executed realizes the method according to the present invention.

According to the above-mentioned aspects of this invention, the reply information is transmitted to the external device and stored in the memory, and the reply information is transmitted to the external device when abnormality occurs to connection. Thus, compared with conventional rollback from the external device, the traffic of a communication line can be reduced and communication load can be reduced when abnormality occurs to communication.

Other objects and features of this invention will become apparent from the following description with reference to the accompanying drawings.

### BRIEF DESCRIPTION OF THE DRAWINGS

FIG. 1 is a block diagram showing the constitution of one embodiment according to the present invention;

FIG. 2 is a sequence view for describing the operation of the embodiment;

FIG. 3 is a flow chart for describing the operation of a transaction guarantee section 44 shown in FIG. 1;

FIG. 4 is a flow chart for describing the operation of transaction notification agents 34₁ to 34ₙ shown in FIG. 1;

FIG. 5A to FIG. 5C are views showing the formats of reply information and connection notification information used in the embodiment;

FIG. 6 is a flow chart for describing the operation of the transaction guarantee section 44 shown in FIG. 1;

FIG. 7A and FIG. 7B are views showing the format of reply information used in the embodiment;

FIG. 8 is a block diagram showing a modification of the embodiment;

FIG. 9 is a block diagram showing the constitution of a conventional CORBA communication system; and

FIG. 10 is a sequence view for describing the operation of the conventional CORBA communication system.

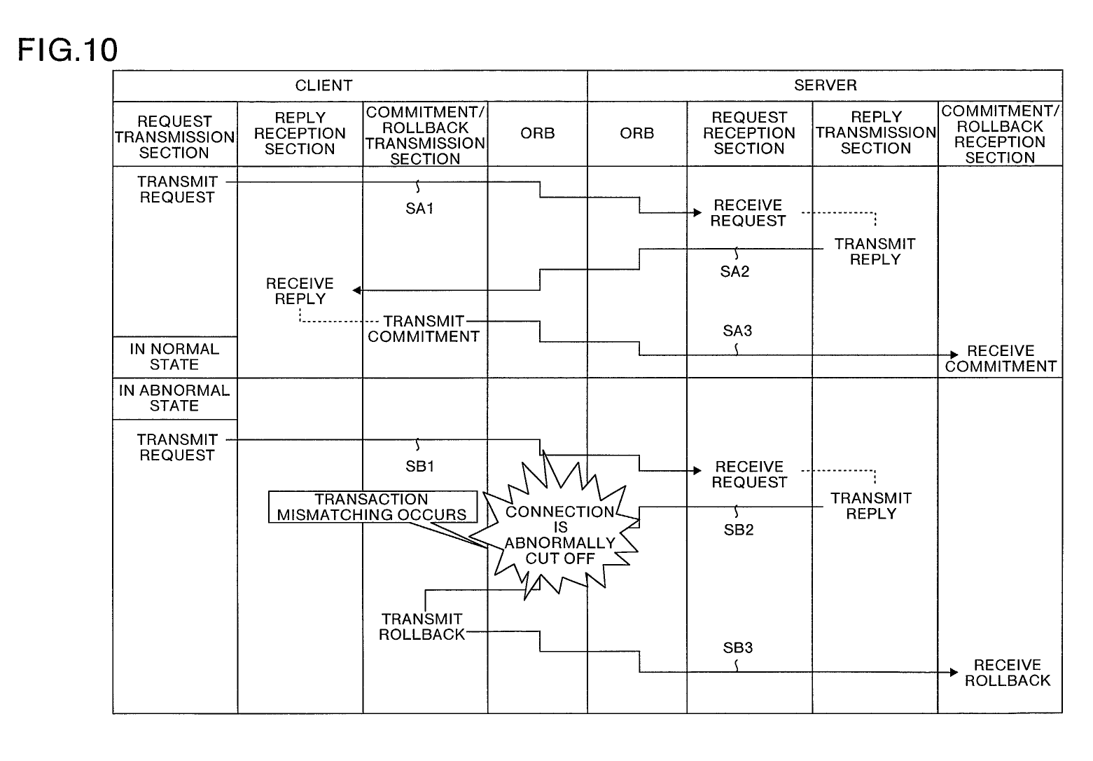

### DESCRIPTION OF THE PREFERRED EMBODIMENTS

A preferred embodiment of the method and device for data communication according to the present invention will be described in detail hereinafter with reference to the accompanying drawings.

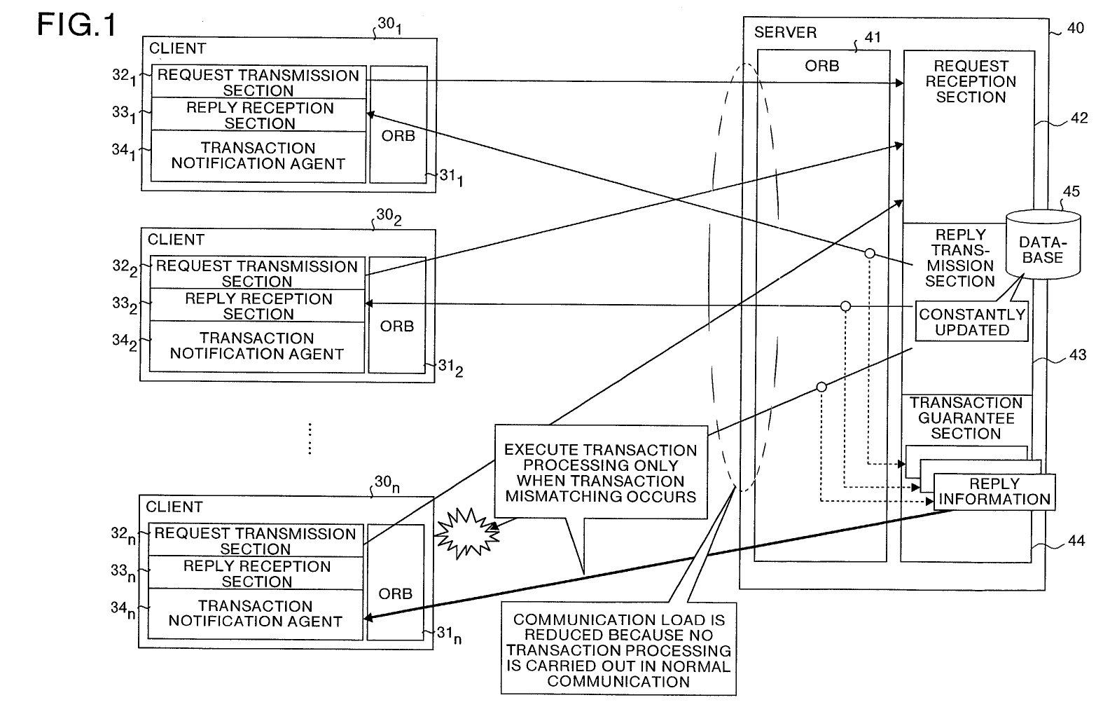

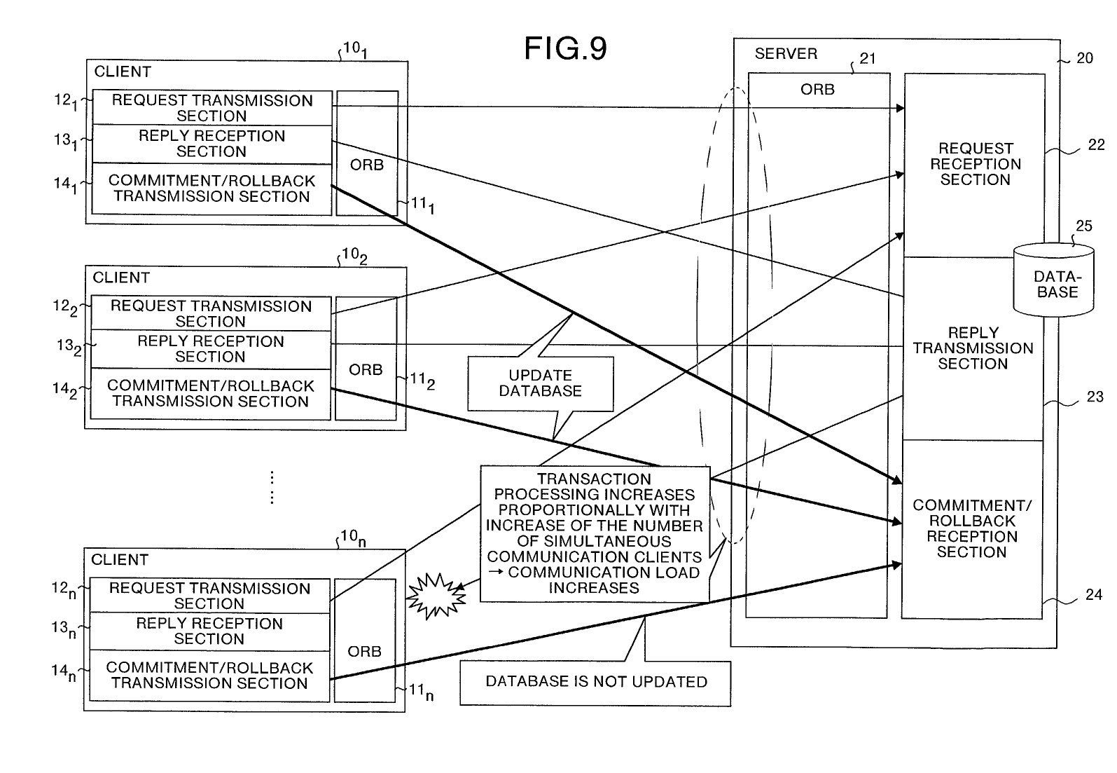

FIG. 1 is a block diagram showing the constitution of one embodiment according to the present invention. FIG. 1 shows data communication utilizing a CORBA consisting of n clients 30₁ to 30ₙ and a server 20 connected to the clients 30₁ to 30ₙ through a network (not shown). Each of the clients 30₁ to 30ₙ communicates with the server 20 in accordance with a predetermined protocol. It should be noted here that the data communication system shown in FIG. 1 has no factor for increasing communication load of commitment/rollback compared with the conventional CORBA communication system (see FIG. 9) stated above.

In the client 30₁, an ORB 31ₗ is a software bus mediating between the client 30₁ and the server 20. This ORB 31₁ has an initial object reference including an IP address and a PORT number of the client 30₁ itself.

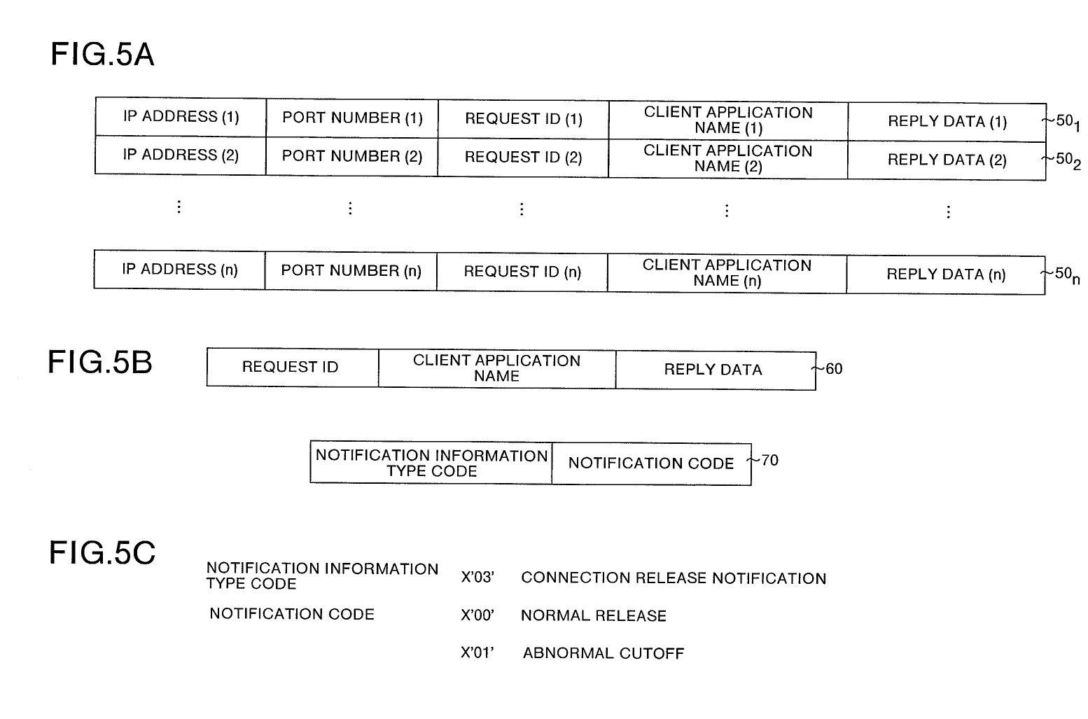

A request transmission section 32₁ has a function of transmitting the above-stated request to the server 20. Here, the ORB 31₁ acquires a request ID for identifying the request at the time of transmitting the request and adds this request ID to the request. A reply reception section 33₁ receives reply information 50₁ shown in FIG. 5A.

This reply information 50₁ consists of an IP address (1), a PORT number (1), a request ID (1), a client application name (1) and reply data (1). This reply information 50₁ is information transmitted from a reply transmission section 43 to be described later as a reply to the request.

The request ID is a request ID acquired by the ORB 31₁. The client application (1) is the names of the request transmission section 32₁, and reply reception section 33₁ of the client 30₁ . The reply data (1) is data transmitted from the reply transmission section 43 of the server 40.

The transaction notification agent 34₁ has a function of matching a client 301-side transaction when connection is abnormally cut off, based on notification reply information 60 in a format shown in FIG. 5B. The notification reply information 60 consists of a request ID, a client application name and reply data.

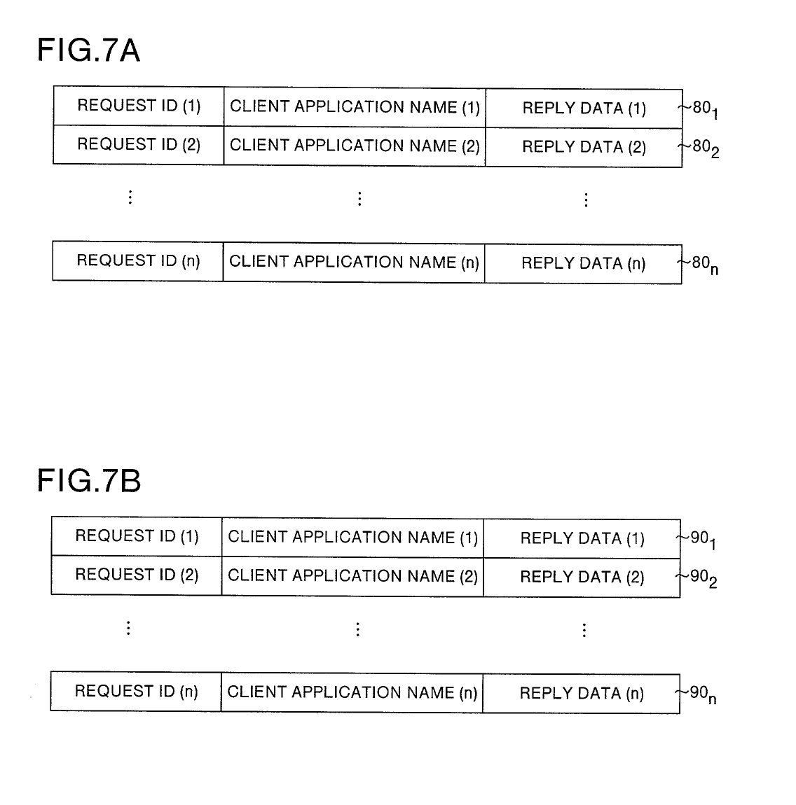

FIG. 7B shows a concrete example of the notification reply information 60. Notification reply information 90₁ is information transmitted from a transaction guarantee section 44 to be described later if abnormality occurs to the connection between the client 30₁ and the server 40. The information 90₁ consists of a request ID (1), a client application name (1) and reply data (1). This notification reply information 90₁ corresponds to the reply information 50₁ shown in FIG. 5A. The reply notification agent 34₁ specifies a request from the notification reply information 90₁ when abnormality occurs to the connection and makes transaction matching based on the specification result.

In the client 30₂, an ORB 31₂ is a software bus mediating between the client 30₂ and the server 20. This ORB 31₂ has an initial object reference including an IP address and a PORT number of the client 30₂ itself.

A request transmission section 32₂ has a function of transmitting the above-stated request to the server 20. Here, the ORB 31₂ acquires a request ID for identifying the request at the time of transmitting the request and adds this request ID to the request. A reply reception section 33₂ receives reply information 50₂ shown in FIG. 5A.

This reply information 50₂ consists of an IP address (2), a PORT number (2), a request ID (2), a client application name (2) and reply data (2). This reply information 50₂ is information transmitted from the reply transmission section 43 to be described later as a reply to the request.

The request ID is a request ID acquired by the ORB 31₂. The client application (2) is the names of the request transmission section 32₂ and reply reception section 33₂ of the client 30₂. The reply data (2) is data transmitted from the reply transmission section 43 of the server 40.

The transaction notification agent 34₂ has a function of matching a client 30₂-side transaction when connection is abnormally cut off, based on notification reply information 90₂ shown in FIG. 7B. The notification reply information 90₂ is information transmitted from the transaction guarantee section 44 to be described later if abnormality occurs to the connection between the client 30₂ and the server 40, and consists of a request ID (2), a client application name (2) and reply data (2).

The notification reply information 90₂ corresponds to the reply information 50₂ shown in FIG. 5A. The transaction notification agent 34₂ specifies a request from the notification reply information 90₂ when abnormality occurs to the connection and makes transaction matching based on the specification result.

In the client 30ₙ, an ORB 31ₙ is a software bus mediating between the client 30ₙ and the server 20. This ORB 31ₙ has an initial object reference including an IP address and a PORT number of the client 30ₙ itself.

A request transmission section 32ₙ has a function of transmitting the above-stated request to the server 20. Here, the ORB 31ₙ acquires a request ID for identifying the request at the time of transmitting the request and adds this request ID to the request. A reply reception section 33ₙ receives reply information 50ₙ shown in FIG. 5A.

This reply information 50ₙ consists of an IP address (n), a PORT number (n), a request ID (n), a client application name (n) and reply data (n). This reply information 50ₙ is information transmitted from the reply transmission section 43 to be described later as a reply to the request.

The request ID is a request ID acquired by the ORB 31ₙ. The client application (n) is the names of the request transmission section 32ₙ and reply reception section 33ₙ of the client 30ₙ. The reply data (n) is data transmitted from the reply transmission section 43 of the server 40. It is noted that reply information 80to 80ₙ shown in FIG. 7B may be used instead of the reply information 50₁ to 50ₙ shown in FIG. 5A in one embodiment.

The transaction notification agent 34ₙ has a function of matching a client 30ₙ-side transaction when connection is abnormally cut off, based on notification reply information 90ₙ shown in FIG. 5B. The notification reply information 90ₙ is information transmitted from the transaction guarantee section 44 to be described later if abnormality occurs to the connection between the client 30ₙ and the server 40, and consists of a request ID (n), a client application name (n) and reply data (n).

In addition, the notification reply information 90ₙ corresponds to the reply information 50ₙ shown in FIG. 5A. The transaction notification agent 34ₙ specifies a request from the notification reply information 90ₙ when abnormality occurs to the connection and makes transaction matching based on the specification result.

The server 40 has a function of receiving requests from the clients 30₁ to 30ₙ, a function of transmitting reply information 50₁ to 50ₙ as replies to the requests, to the clients 30₁ to 30ₙ, respectively, a function of monitoring connection between the server 40 and the clients 30₁ to 30ₙ and a function of updating a database 45.

To be specific, the server 40 consists of an ORB 41, a request reception section 42, a reply transmission section 43, a transaction guarantee section 44 and a database 45. The ORB 41 is a software bus mediating between the server 40 and the clients 30₁ to 30ₙ. This ORB 41 has a function of transmitting the reply information 50₁ to 50ₙ (see FIG. 5A) and a function of monitoring connection between the server 40 and the clients 30₁ to 30ₙ.

Also, the ORB 41 notifies the transaction guarantee section 44 of connection monitoring result information 70 in a format shown in FIG. 5C as a connection monitoring result. The connection monitoring result information 70 consists of a notification information type code (X′03′) and a notification code (X′00 or X′01′) . The notification type code is a code for notifying that that connection was released. The notification code is a code for notifying that connection was normally released or abnormally cut off when releasing the connection.

The request reception section 42 has a function of receiving requests from the clients 30₁ to 30ₙ. The reply transmission section 43 has a function of transmitting reply data (see FIG. 5B) as replies to the above-stated requests to the ORB 41. The transaction guarantee section 44 has a function of avoiding client-side transaction mismatching following the abnormal cutoff of the connection and guaranteeing a transaction. In addition, the transaction guarantee section 44 has a function of transmitting notification reply information 90₁ to 90ₙ to the clients 30₁ to 30ₙ respectively based on the connection monitoring result information 70 (in case of abnormal release) from the ORB 41.

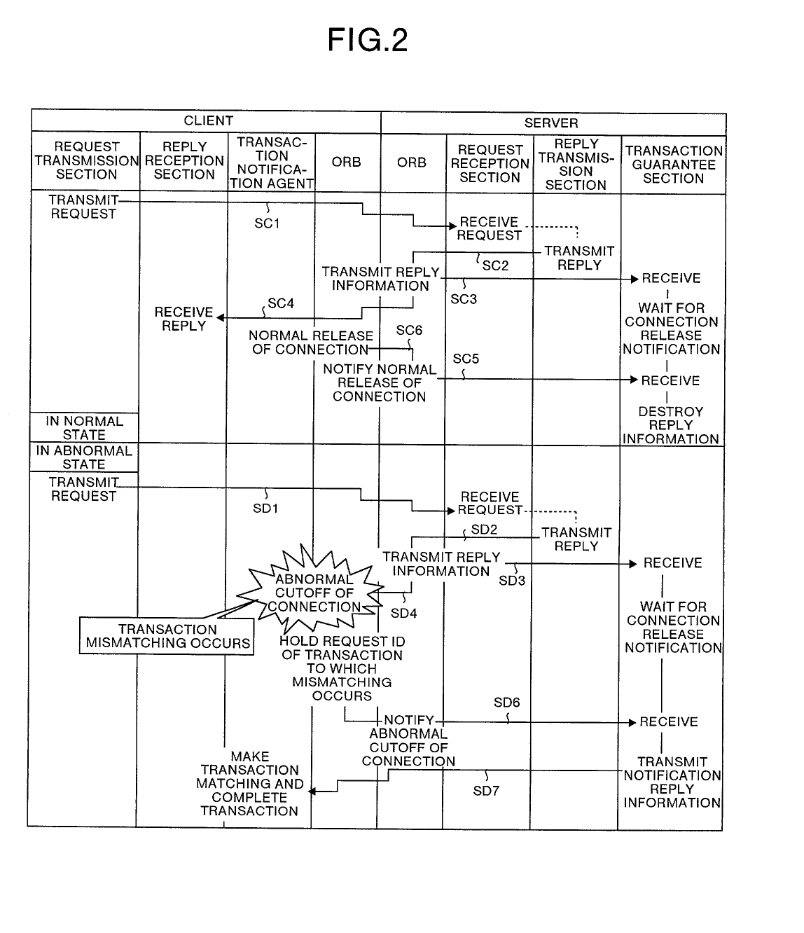

Next, the operation of the above-stated embodiment will be described with reference to FIG. 2 to FIG. 7B. FIG. 2 is a sequence view for describing the operation of the embodiment according to the present invention. First, description will be given, centering around the operation between the client 30ₙ and the server 40 in a normal state. It is noted that the operation between each of the clients 30₁ to 30ₙ₋₁ (not shown) and the server 40 is the same as that between the client 30ₙ and the server 40 described hereinafter.

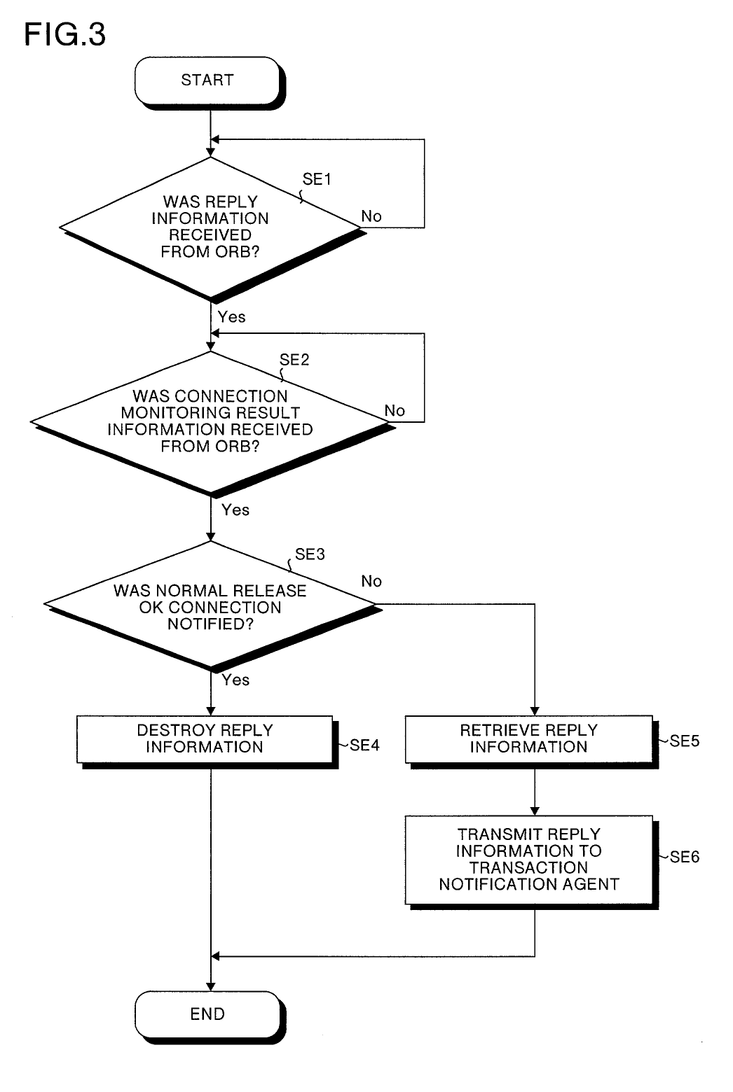

Operation in case of the normal state will now be explained. In a step SE1 shown in FIG. 3, the transaction guarantee section 44 judges whether or not the section 44 received reply information (see FIG. 7A) from the ORB 41 of the server 40. If the judgment result is ‘No’, the transaction guarantee section 44 repeats the same judgment.

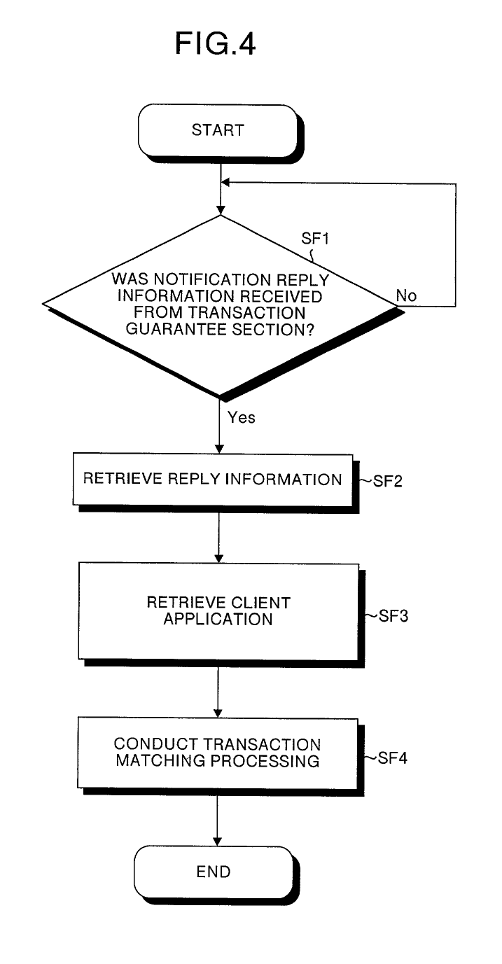

In a step SF1 shown in FIG. 4, on the other hand, the transaction notification agents 34₁ to 34ₙ of the clients 30₁ to 30ₙ judges whether or not the agent 34ₙ received notification reply information (see FIG. 7B) from the transaction guarantee section 44. If the judgment result is ‘No’, the transaction notification agent 34ₙ repeats the same judgment.

Here, in a step SC1 shown in FIG. 2, the request transmission section 32ₙ of the client 30ₙ transmits a request to the server 40. At this time, the ORB 31ₙ acquires a request ID(n) shown in FIG. 5A and adds the acquired request ID(n) to the request. The request (with the request ID) is received by the request reception section 42 of the server 40.

In a step SC2, the reply transmission section 43 transmits reply data (n) shown in FIG. 5A to the ORB 41. Following this, in a step SC3, the ORB 41 transmits reply information 50ₙ shown in FIG. 5A to the transaction guarantee section 44. This reply information 50ₙ is received by the transaction guarantee section 44.

Thereafter, the transaction guarantee section 44 determines the judgment result of the step SE1 shown in FIG. 3 as ‘Yes’ and stores reply information 50₁ in a memory (not shown). In a step SE2, the transaction guarantee section 44 judges whether or not the section 44 received connection monitoring result information 70 (see FIG. 5B) from the ORB 41. If the judgment result is ‘No’, the transaction guarantee section 44 repeats the same judgment.

Next, in a step SC4 shown in FIG. 2, the ORB 41 transmits the reply information 50ₙ to the reply reception section 33ₙ of the client 30ₙ. This reply information 50ₙ is received by the reply reception section 33ₙ and then stored in the memory (not shown).

When the connection between the client 30ₙ and the server 40 is normally released, the ORB 41 transmits the connection monitoring result information 70 (see FIG. 5C), as a notification that the connection was normally released, to the transaction guarantee section 44 in a step SC6. This connection monitoring result information 70 (normal release) is received by the transaction reception section 44.

Thereafter, the transaction guarantee section 44 determines the judgment result of the step SE2 shown in FIG. 3 as ‘Yes’. In a step SE3, the transaction guarantee section 44 judges whether or not the connection was normally released while referring to the notification code of the received connection monitoring result information 70, and, in this case, determines the judgment result as ‘Yes’. In a step SE4, the transaction guarantee section 44 destroys the reply information 50ₙ (see FIG. 5A) stored in the memory.

Next, operation in case of the abnormal state, i.e. when connection between the client 30ₙ and the server 40 shown in FIG. 1 is abnormally cut off will be explained. In the step SE1 shown in FIG. 3, the transaction guarantee section 44 judges whether or not the section 44 received the reply information (see FIG. 7A) from the ORB 41. If the judgment result is ‘No’, the transaction guarantee section 44 repeats the same judgment.

In the step SF1 shown in FIG. 4, on the other hand, the transaction notification agents 34to 34ₙ of the clients 30₁ to 30ₙ judges whether or not the agent 34 received notification reply information (see FIG. 7B) from the transaction guarantee section 44. If the judgment result is ‘No’, the transaction notification agent 34ₙ repeats the same judgment.

Here, in the step SD1 shown in FIG. 2, the request transmission section 32ₙ of the client 30ₙ transmits a request. At this time, the ORB 31ₙ acquires a request ID(n) shown in FIG. 5A and adds the acquired request ID(n) to the request. The request (with the request ID) is received by the request reception section 42 of the server 40.

In the step SD2, the reply transmission section 43 transmits reply data (n) shown in FIG. 5A to the ORB 41. Following this, in the step SD3, the ORB 41 transmits reply information 50ₙ shown in FIG. 5A to the transaction guarantee section 44. This reply information 50ₙ n is received by the transaction guarantee section 44.

Thereafter, the transaction guarantee section 44 determines the judgment result of the step SE1 shown in FIG. 3 as ‘Yes’ and stores the reply information 50₁ in the memory (not shown). In the step SE2, the transaction guarantee section 44 judges whether or not the section 44 received connection monitoring result information 70 (see FIG. 5B from the ORB 41. If the judgment result is ‘No’, the transaction guarantee section 44 repeats the same judgment.

Next, in the step SD4 shown in FIG. 2, the ORB 41 transmits the reply information 50ₙ to the reply reception section 33ₙ of the client 30ₙ. This reply information 50ₙ is received by the reply reception section 33ₙ and then stored in the memory (not shown).

Here, if the connection between the client 30ₙ and the server 40 was abnormally cut off, the ORB 41 transmits the connection monitoring result information 70 (see FIG. 5C), as a notification that the connection was abnormally cut off, to the transaction guarantee section 44 in the step SD6. At this time, transaction mismatching occurs. The connection monitoring result information 70 (abnormal cutoff) is received by the transaction guarantee section 44.

Thereafter, the transaction guarantee section 44 determines the judgment result of the step SE2 shown in FIG. 3 as ‘Yes’. In the step SE3, the transaction guarantee section 44 judges whether or not the connection was normally released while referring to the notification code of the received connection monitoring result information 70, and, in this case, determines the judgment result as ‘No’. In the step SE5, the transaction guarantee section 44 retrieves reply information 50ₙ (see FIG. 5A) corresponding to the abnormal cutoff of connection from (a plurality of) reply information stored in the memory while using an IP address and a PORT number corresponding to the abnormal cutoff of connection as a key.

In a step SE6 (or step SD7 in FIG. 2), the transaction guarantee section 44 transmits reply information 90ₙ (see FIG. 7B) corresponding to the reply information 50ₙ to the transaction notification agent 34ₙ of the client 30ₙ. This notification reply information 90ₙ is received by the transaction notification agent 34ₙ.

Following this, the transaction notification agent 34ₙ determines the judgment result of a step SF1 show in FIG. 4 as ‘Yes’. In a step SF2, the transaction notification agent 34ₙ retrieves notification reply information 90ₙ corresponding to the abnormal cutoff of connection from among a plurality of reply information stored in the memory while using the client application name (or request ID) of the received notification reply information 90ₙ as a key. In a step SF4, the transaction notification agent 34₁ makes transaction matching based on the reply data in the above-stated notification reply information 90ₙ.

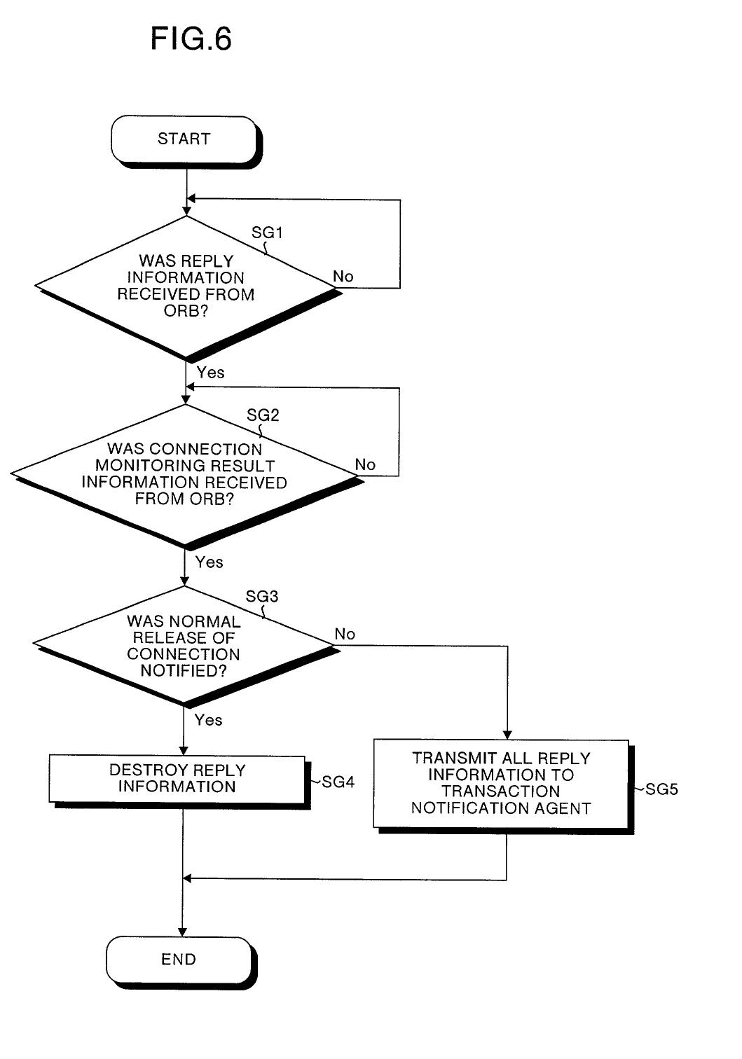

In this embodiment, description has been given to a case where the reply information is retrieved in the step SE5 shown in FIG. 3 and the notification reply information corresponding to the retrieved reply information is transmitted to the transaction notification agent. Alternatively, all the reply information stored in the memory may be transmitted to the transaction notification agent without making a retrieval as seen in a step SG5 shown in FIG. 6. Steps SG1 to SG4 shown in FIG. 6 correspond to the steps SE1 to SE4 shown in FIG. 3.

As stated above, according to this embodiment, the notification reply information is transmitted to the clients 30₁ to 30ₙ and stored in the memory, and the notification reply information is transmitted to the clients 30₁ to 30ₙ when abnormality occurs to connection. Thus, compared with conventional rollback from the clients 30₁ to 30ₙ, network traffic can be reduced and communication load at a time when abnormality occurs to communication can be reduced.

Furthermore, if connection is normally released, the reply information stored in the memory is destroyed. Thus, it is possible to enhance efficiency for utilizing the memory.

In addition, since the request ID is included in the notification reply information, the request ID corresponding to the abnormal cutoff of connection can be easily specified based on the request ID and transaction matching can be made following the abnormal cutoff of connection.

A preferred embodiment according to the present invention has been described in detail with reference to the drawings so far. The concrete examples of the constitution of the invention should not be limited to this embodiment and any changes in design within the scope of the invention are included in the invention.

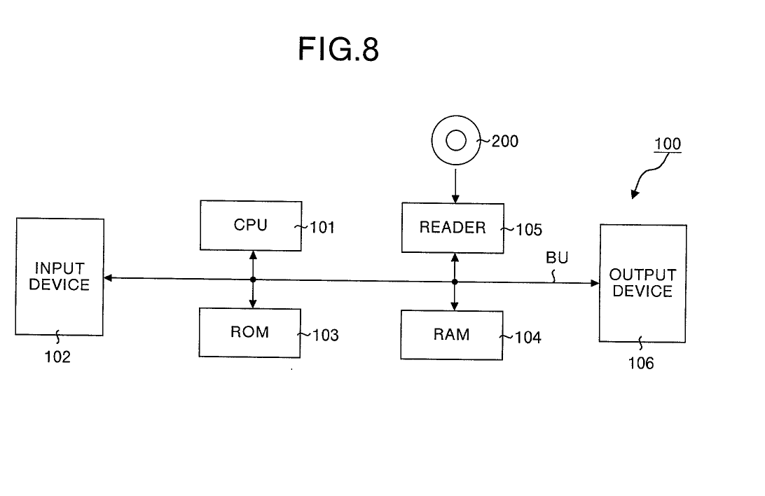

For example, a data communication program for realizing the functions of the server 40 may be recorded on a computer readable recording medium 200 shown in FIG. 8, and the data communication program recorded on the recording medium 200 may be read and executed by a computer 100 shown in FIG. 8 to thereby realize the functions of the server 40.

The computer 100 shown in FIG. 8 consists of a CPU (Central Processing Unit) 101 executing the above-stated data communication program, an input device 102 such as a keyboard, a mouse or the like, an ROM (Read-only Memory) 103 storing various data, an RAM (Random-access Memory) 104 storing operation parameters and the like, a reader 105 reading the data communication program from the recording medium 200, an output device 106 such as a display, a printer or the like, and a bus BU mutually connecting the constituent elements of the computer 100.

The CPU 101 reads the data communication program recorded on the recording medium 200 through the reader 105 and then executes the data communication program, thereby realizing the functions of the server 40 stated above. The recording medium 200 may be a transmission medium, such as a network, temporarily holding data as well as a portable type recording medium such as an optical disk, a floppy disk or a hard disk.

As stated so far, according to the present invention, the reply information is transmitted to the external device and stored in the memory, and the reply information is transmitted to the external device when abnormality occurs to connection. Thus, compared with conventional rollback from the external device, the present invention has advantages in that the traffic of a communication line can be reduced and that communication load can be reduced when abnormality occurs to communication.

Moreover, the present invention has an advantage in that efficiency for utilizing the memory can be enhanced since the reply information stored in the memory is destroyed if connection is normally released.

In addition, according to the present invention, the identification information for identifying requests is included in the reply information. Due to this, the present invention can advantageously specify a request corresponding to the abnormal cutoff of connection and make transaction matching following the abnormal cutoff of connection.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A data communication device for establishing data communication with an external communication device, comprising:
a reply unit for, if a request is issued from said external device, transmitting reply information corresponding to the request, and for storing the reply information in a memory;
a connection monitoring unit which monitors connection with said external device; and
a transmission unit which transmits the reply information corresponding to the connection with said external device and stored in said memory to said external communication device if the connection with said external device is abnormally cut off based on the result of monitoring by said connection monitoring unit.

2. The data communication device according to claim 1, further comprising:
a reply information destruction unit which destroys the reply information stored in said memory if the connection with said external device is normally released based on the result of monitoring by said connection monitoring unit.

3. The data communication device according to claim 1, wherein
identification information for identifying the request from said external device is included in the reply information transmitted by said reply unit.

4. A data communication method for establishing data communication with an external communication device, comprising:
a reply step of, if a request is issued from said external device, transmitting reply information corresponding to the request, and of storing the reply information in a memory;
a connection monitoring step of monitoring connection with said external device; and
a transmission step of transmitting the reply information corresponding to the connection with said external device and stored in said memory to said external communication device if the connection with said external device is abnormally cut off based on the result of monitoring in the connection monitoring step.

5. A computer readable medium for storing instructions, which when executed on a computer, causes the computer to perform:
a reply step of, if a request is issued from said external device, transmitting reply information corresponding to the request, and of storing the reply information in a memory;
a connection monitoring step of monitoring connection with said external device; and
a transmission step of transmitting the reply information corresponding to the connection with said external device and stored in said memory to said external communication device if the connection with said external device is abnormally cut off based on the result of monitoring in the connection monitoring step.
